(19) United States
(12) Patent Application Publication
(10) Pub. No.: US 2025/0363294 A1
(43) Pub. Date: Nov. 27, 2025

(54) SYSTEMS AND METHODS FOR GENERATING LONG FORM BUSINESS CONTENT USING PRIVATE ENTERPRISE DATA

(71) Applicant: Ema Unlimited Inc., Mountain View, CA (US)

(72) Inventors: Souvik Sen, Sunnyvale, CA (US); Surojit Chatterjee, Los Altos, CA (US); Shubham Khandelwal, Bengaluru (IN)

(21) Appl. No.: 18/672,005

(22) Filed: May 23, 2024

(51) Int. Cl. G06F 40/186; G06F 40/177; G06F 40/40

(52) U.S. Cl. CPC G06F 40/186; G06F 40/177; G06F 40/40

(57) ABSTRACT

Systems and methods for using large language models (LLM) for generating personalized business content items, such as documents and presentations, by generating content item templates having sections and automatically populating content in its sections by leveraging LLM generated semantic graphs are described. A request to generate a content item is received. A table of contents template having a plurality of nested sections is generated based on the received request. Leveraging an LLM, a semantic graph that semantically organized data from a plurality of enterprise private data sources is generated. A query to the semantic graph for the most fine-gained section of the template is made to obtain relevant indexed data. A write operation is performed to write the data in the most fine-gained section. The query and write operation for each section in the template based on the section's hierarchy is made until all template sections are completed.

### FIELD OF INVENTION

Embodiments of the present disclosure relate to using large language models (LLMs) for generating business content items, such as documents and presentations, by creating content item templates and automatically populating content in the sections of the content item template by leveraging LLM generated semantic graphs. The embodiments of the present disclosure also relate to populating the content item template based on hierarchy of the sections in the content item template.

### BACKGROUND

A common use for artificial intelligence (AI) chatbots, such as ChatGPT™, Bard™, Llama™, Bing Chat™, Claude™, and Jasper™, is to provide answers for various types of queries, write code, or generate documents such as emails, resumes, and letters. Although the chatbots are very useful in leveraging large language models (LLMs) to provide such answers or generate documents, they are still in their early stages and have a lot of room for improvement.

When a user asks a question or requests the chatbot to create a document, the chatbots leverage LLMs to provide an answer or generate a document based on the framing of the query. Regardless of which person is asking the question or making the request, if the request is the same, the answer or the document generated is the same or substantially the same. A drawback with providing the same answer or generating a same type of document irrespective of which person is asking the question is that the answer or the document generated is generic and not personalized to the person asking the question or making the request to generate the document.

Chatbots also use public LLMs that are trained with public data to provide answers to the queries or to generate documents. Since the public data is the same for everyone, if the query is the same or substantially the same, a generic document that is substantially the same is generated for all users. To the extend private LLMs are utilized, such as in a company, the same data and the same answer is provided to anyone in the company. A drawback with this approach is that public data or private data is generically used, and not customized to any specific individual. In addition to providing non-personalized answers or creating non-personalized documents, such use may reveal confidential data to employees that are not authorized to access certain data (since the same private data may be used for all).

Chatbots also have limitation as to the number of characters that can be inputted and outputted. For example, certain version of ChatGPT have a 4096-character limit or a 10-page limit or are limited to their context window. Having such a limitation prevents such chatbots from creating larger size documents that are several pages long. Not only can they not create large size documents, the current chatbots also cannot generate documents that have several layers and sections in a coherent manner (i.e., cannot handle a higher level of complexity that requires coherency across the document).

Chatbots also take a single input at a time to then use an LLM and provide an answer. Although the single input can be multiple questions, the response provided is either one single response or a response that covers one topic or context. Since larger documents typically have serval topics of different context that may be systematically and coherently presented, due to the current limitation of technology, algorithms used, and character limitations, such chatbots cannot handle multiple inputs, especially simultaneous inputs, to then revise the answer or generated document.

As such, there is a need for methods and systems for taking inputs and generating strategically coherent and systematically presented large scale business content items that are personalized to the user and the enterprise and provide technically enhanced synchronization and editing capabilities.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings and disclosure. The various objects and advantages of the disclosure will be apparent upon consideration of the following detailed description, taken in conjunction with the accompanying drawings, in which like reference characters refer to like parts throughout, and in which:

FIG. 1 is a flowchart of an example of a process for generating a long form business content item using private enterprise data, in accordance with some embodiments of the disclosure;

FIG. 2 is a block diagram of an example of a system for generating a long form business content item using private enterprise data, in accordance with some embodiments of the disclosure;

FIG. 3 is a block diagram of an example of an electronic device or user device for generating a long form business content item using private enterprise data, in accordance with some embodiments of the disclosure;

FIG. 4 is a block diagram of an example of private enterprise data organized by genre, topic, or any desired category, in accordance with some embodiments of the disclosure;

FIG. 5 is flowchart of an example of a process for generating a semantic graph that represents data from data sources and file storage, in accordance with some embodiments of the disclosure;

FIG. 6 is a block diagram of user requests and suggested user requests for generating a long form business content item, in accordance with some embodiments of the disclosure;

FIG. 7 is an example of a user request for generating a long form business content item, in accordance with some embodiments of the disclosure;

FIG. 8 is flowchart of an example of a process for generating a template that is to be populated with content, such as private enterprise data, to generate the long form business content item, in accordance with some embodiments of the disclosure;

FIG. 9 is an example of a user interface for providing information that may be used to generate the template, in accordance with some embodiments of the disclosure;

FIG. 10 is an example of layers or tiers of sections and their hierarchy in the generated template, in accordance with some embodiments of the disclosure;

FIG. 11 is an example of a generated template, in accordance with some embodiments of the disclosure;

FIG. 12 is a flowchart of an example of a process for performing a search query to populate section(s) of the generated template, in accordance with some embodiments of the disclosure;

FIG. 13 is an example of a bottoms up approach in writing content into the generated template, in accordance with some embodiments of the disclosure;

FIG. 14 is an example of a querying and writing order based on section hierarchy for writing content into the generated template, in accordance with some embodiments of the disclosure;

FIG. 15 is an example of obtaining and processing a per layer or section-by-section feedback in accordance with some embodiments of the disclosure; and

FIG. 16 is an example of receiving feedback, editing and/or suggesting edits based on feedback, and regenerating the write-up, in accordance with some embodiments of the disclosure.

### DETAILED DESCRIPTION

In accordance with some embodiments disclosed herein, some of the above-mentioned limitations are overcome by leveraging a large language model (LLM) to generate a long form business content item using private enterprise data. In accordance with some embodiments disclosed herein, some of the above-mentioned limitations are also overcome by automatically generating a semantic graph that represents data (or data items) from all private enterprise data sources to which the user is authorized access, generating a template having a plurality of sections that are to be populated with relevant private enterprise data represented in the semantic graph, querying the semantic graph for each section in the generated templated, the querying order being based on section hierarchy with the most fine grained or bottom most subsection being queried first, obtaining data from data sources as represented in the semantic graph in response to the query, and writing in the content in the sections of the generated template to generate the long form business content item.

The generated long form business content item is a coherent document that is logically organized section by section or layer by layer to provide its user with a fully comprehensive document that can be edited section-by-section or layer-by-layer. The per layer or per section feedback allows the system to dynamically and in real time (subject to any system latency) regenerate the section of the document for which feedback was provided and ensure that all other sections, which may refer to the regenerated section or depend on the regenerated section in any form, are also regenerated to the extent needed to maintain data consistency across the entire long form business content item.

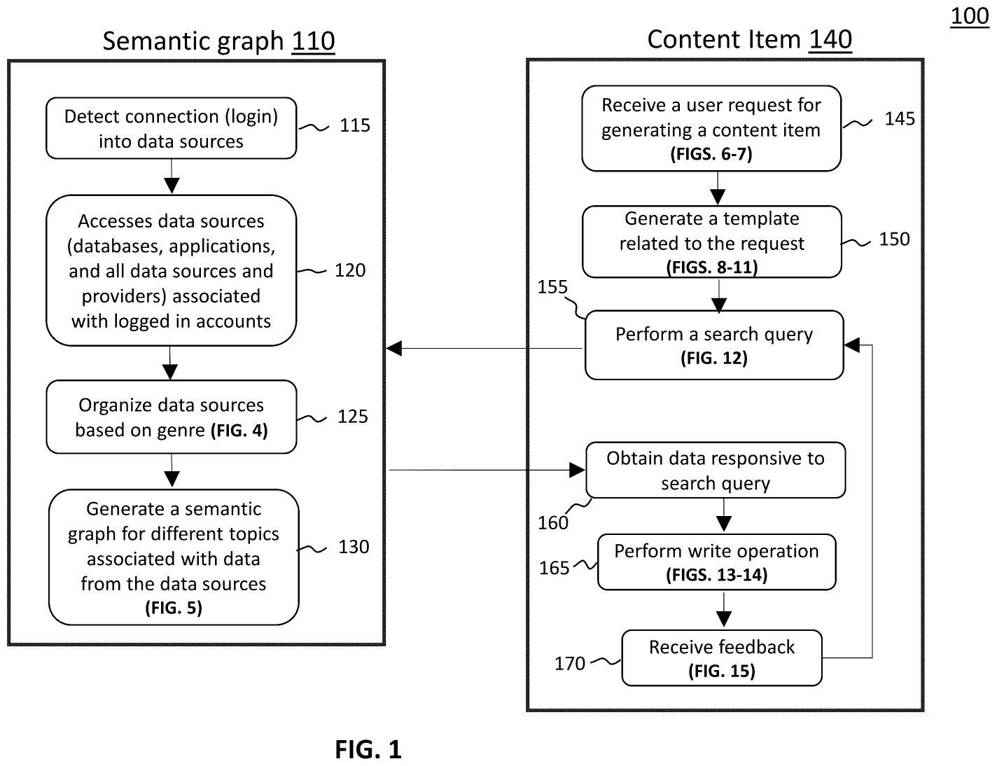

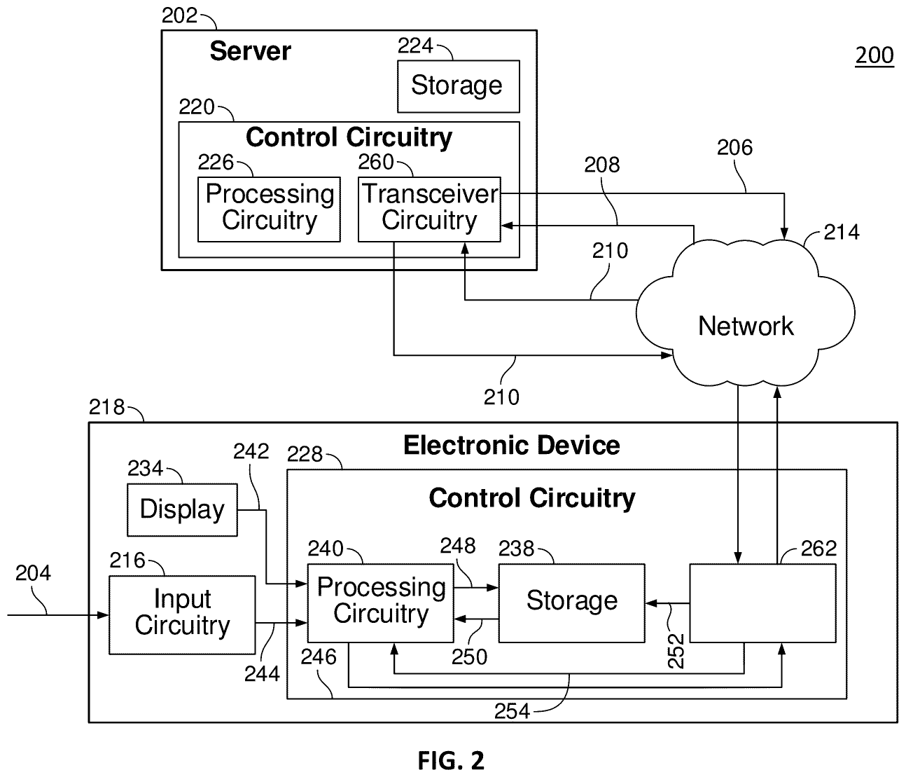

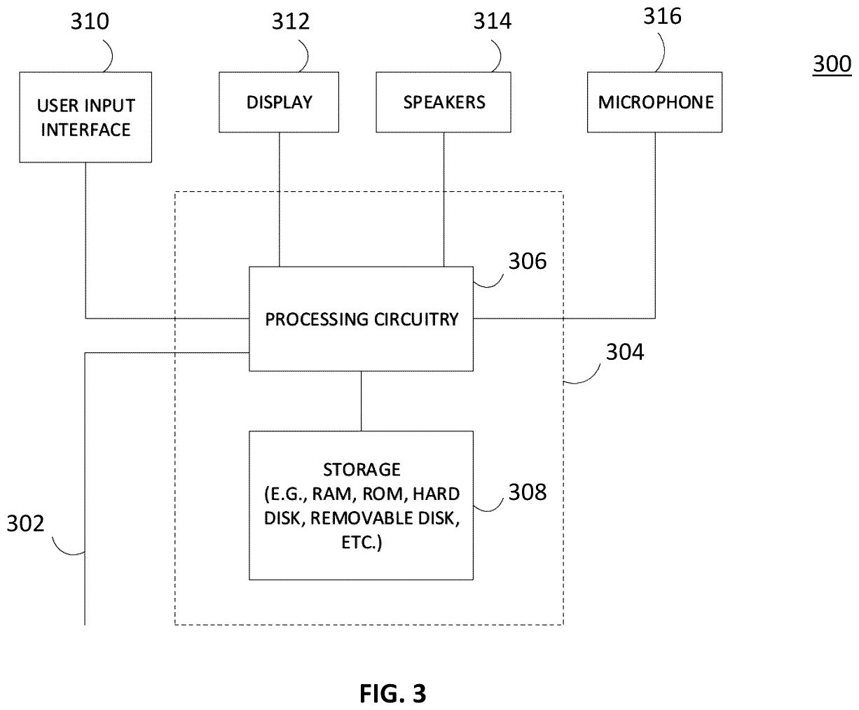

Turning now to figures, FIG. 1 is a flowchart of an example of a process 100 for generating a long form business content item using private enterprise data, in accordance with some embodiments of the disclosure. Process 100, as depicted in FIG. 1, may be implemented, in whole or in part, by systems or devices such as those shown in FIGS. 2-3. One or more actions of the process 100 may be incorporated into or combined with one or more actions of any other process or embodiments described herein. The process 100 may be saved to a memory or storage (e.g., any one of those depicted in FIGS. 2-3) as one or more instructions or routines that may be executed by a corresponding device or system to implement the method 100.

In some embodiments, block 110 relates to a semantic graph and block 140 relates to a long form business content item generated by using the LLM leveraged semantic graph 110. The semantic graph 110, in some embodiments, represents data (also referred to herein as data items) from a plurality of data sources that are private to an enterprise. The semantic graph 110 may index the data from the data sources and when queried, the responsive data that is indexed in the semantic graph may be made available if the user is authorized to access such data. In some embodiments, the semantic graph 110 may be generated prior to receiving or processing a request from a user interface to generate a long form business content item. In other embodiments, the semantic graph and block 140 may also be generated during or after receiving or processing a request from a user interface to generate a long form business content item. Additional details relating to the semantic graph 110, including its creation use are described further below.

At block 115, the control circuitry, such as the control circuitry 220 and/or 228 of FIG. 2, may detect a connection, such as a login, into one or more databases or data sources. The user may be logging into these data sources using a user interface on their user device. For example, a user may be logging in into their accounting applications, HR applications, ticketing applications, E-mail, Sales applications, or to their text messaging applications. The user may also be logging in to a database, library, or some other repository where documents that are authorized for user access are stored. When the user logs in, the system may automatically detect which databases, data sources, applications to which the user has logged in.

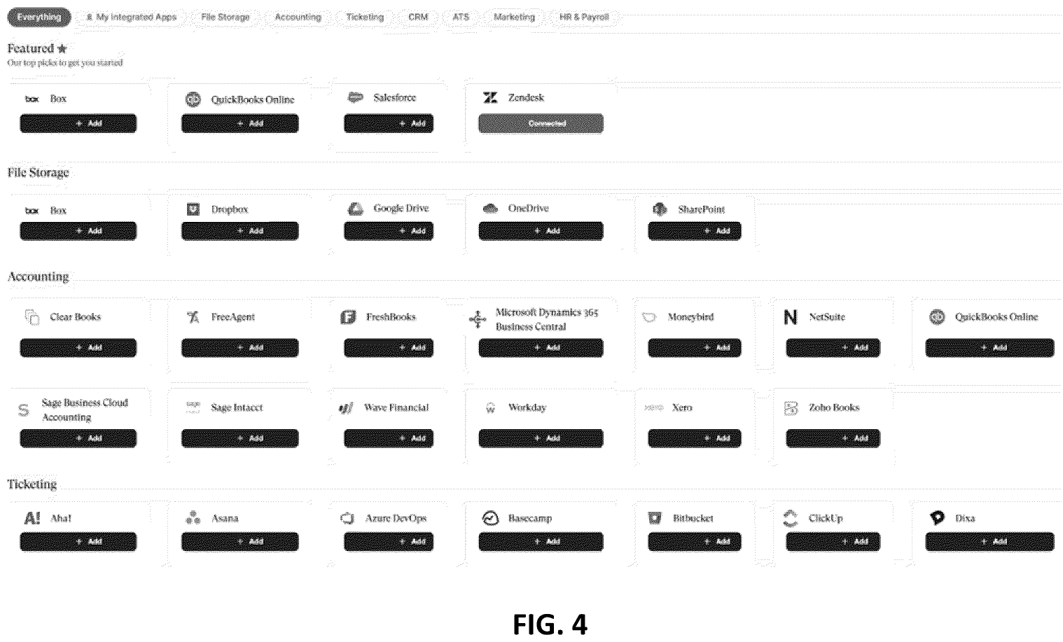

At block 120, in one embodiment, the control circuitry 220 and/or 228 may access all the data sources to which the user has logged in and organize them, such as based on their genre, topic, or some other desired category. One example of such an organization is depicted in FIG. 4. As depicted, some examples of genres may include file storage, accounting, ticketing, sales, marketing, engineering, text, and e-mail. Although one example of organizing data sources is provided and described at block 125, the embodiments are not so limited and other types of organizing, grouping, and clustering of data sources is also contemplated. At block 120, in another embodiment, the control circuitry 220 and/or 228 may access all the data sources to which the user has authorized access to, i.e. permitted to login to, and even if the user has not actually logged into such data sources, as long as the user is authorized and permitted to access data from them, such data sources may also be used and the control circuitry 220 and/or 228 may organize them, such as based on their genre or some other topic.

At block 130, the control circuitry 220 and/or 228 may generate a semantic graph. The semantic graph may be organized, such as by topic, genre, file association, department association, etc., for all data/data items accessed by the control circuitry from different data source to which the user device is authorized access. The organization, which may be topical, may include organizing data relevant to a topic from different data sources together. For example, data relevant to an employee handbook, a request for proposal (RFP), company's financial data, company's products may be grouped together. The semantic graph may semantically associate all topics, words, phrases, content that are related to each other. The semantic graph, in some embodiments, may be organized and generated by an LLM. The LLM may establish the semantic relationships between data items from different data sources.

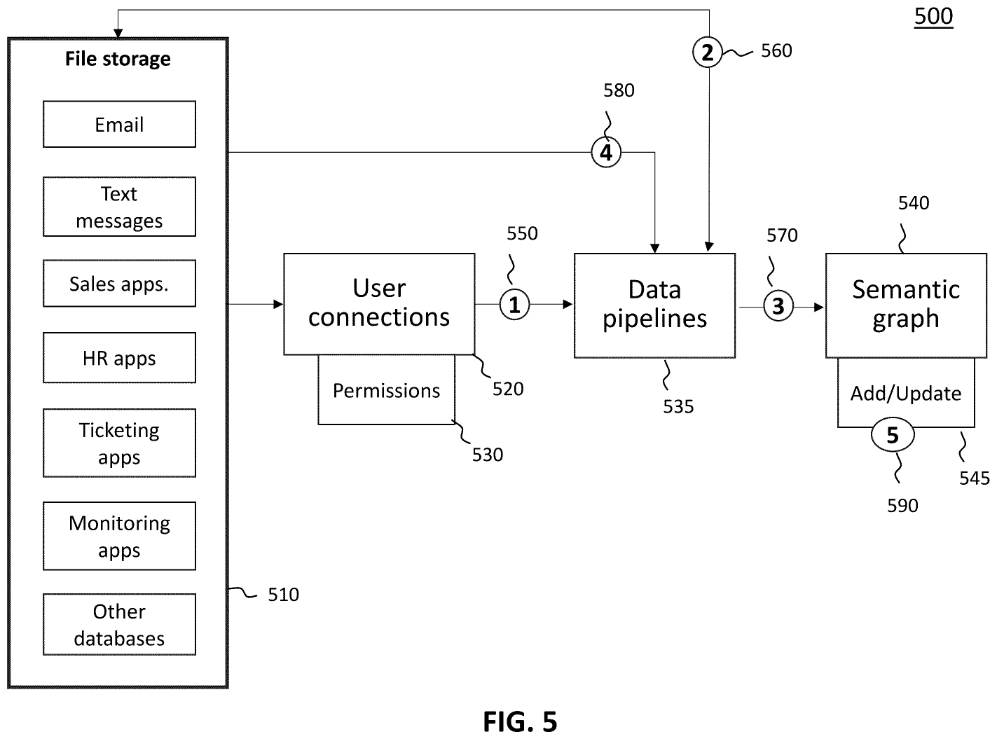

The generated semantic graph may only include data that is authorized to be accessed by a user for whom it is generated to be used. If a user is able to log in to a database, application, or another document repository, the user likely has access to data that is stored in the accessed database, application, or document repository. If the user was not authorized to access such data, the user likely would not be provided login credential to be able to log into such databases, applications, or document repositories that stores such data. As such, only data from those databases, applications, or document repositories to which the user can log in, or is authorized to log in, may be used by the control circuitry 220 and/or 228 to generate the semantic graph. Since the control circuitry 220 and/or 228 may monitor user login and also user login history, such as from using machine learning techniques, the control circuitry 220 and/or 228 may, without any user intervention, use data from such databases, applications, or document repositories to generate the semantic graph. Additional details relating to generating a semantic graph are described below in the description related to FIG. 5.

Block 140 refers to a content item that may be generated using blocks 145-170 and leveraging the semantic graph. At block 145, the control circuitry 220 and/or 228 receives a user request for generating a content item. This may be a large/long form business content item such as a document or presentation using private enterprise data/data items. The request may also be for generating any type of content item, such as a Word™, Excel™, PowerPoint™, Google Docs™, Scrivener™, Pages™, PDFs, Evernote™, QuickBooks™ or any other type of document, file, personal or business document or presentation.

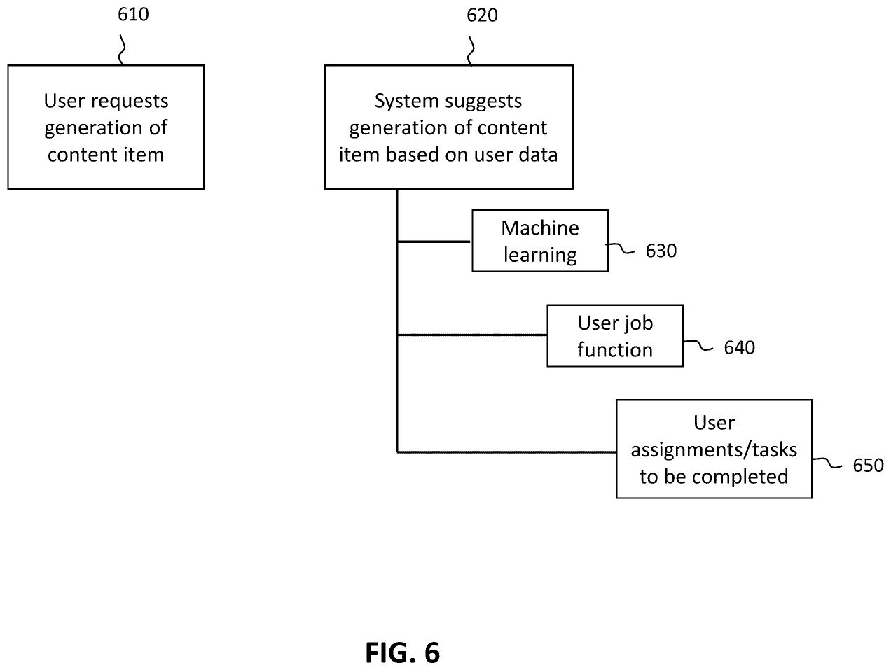

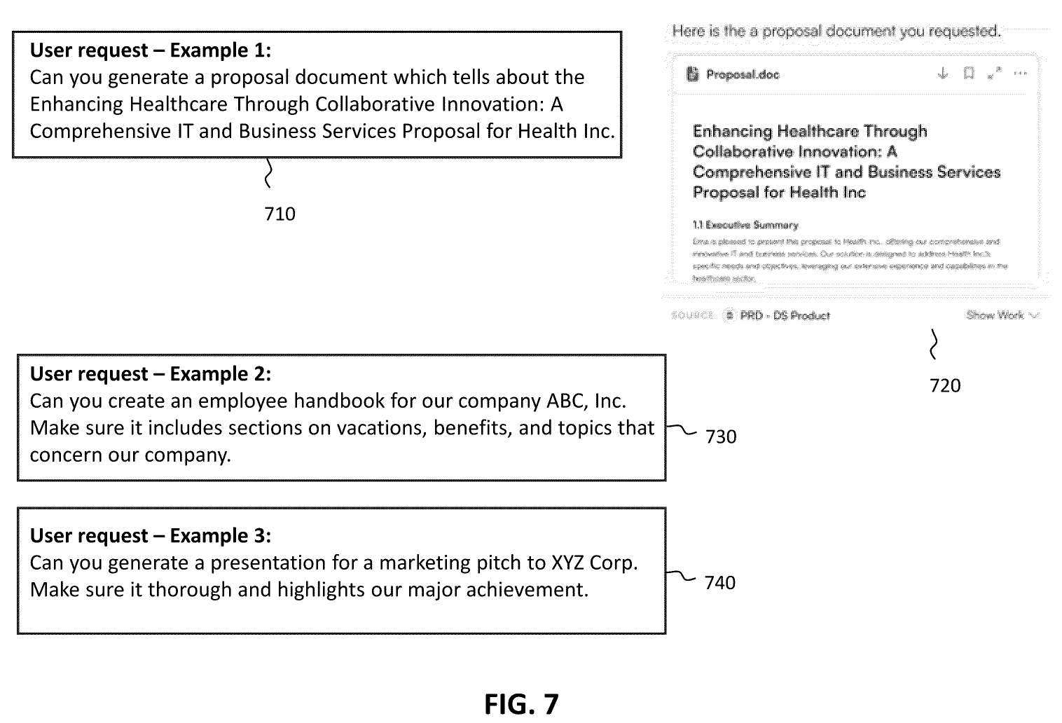

In one embodiment, the request to generate a content item, such as a large business document or presentation using private enterprise data, as depicted in FIG. 6, may be received from a user or suggested to the user by the control circuitry 220 and/or 228. For example, the control circuitry 220 and/or 228 monitoring the user history, job function, tasks for the day, work assignments, meeting minutes, user communications, etc., may determine which projects and tasks are to be performed by the user. Based on such knowledge, which may also be obtained from machine learning, the control circuitry 220 and/or 228 may suggest the type of documents and presentations to the user device for generation. The control circuitry 220 and/or 228 may provide the recommendation for the user's selection and if selected may receive the selection at block 145 and perform the next steps in FIG. 1. For example, the user may receive an email in which a colleague may ask the user, have you started on the Annual Sales Report. Since the control circuitry 220 and/or 228 may be provided access to the user's email, it may analyze the email and automatically suggest to the user to generate the Annual Sales Report and provide the next steps if the user approves. In another example, as depicted in FIG. 7, the user may provide details of the type of long form business content item to be generated.

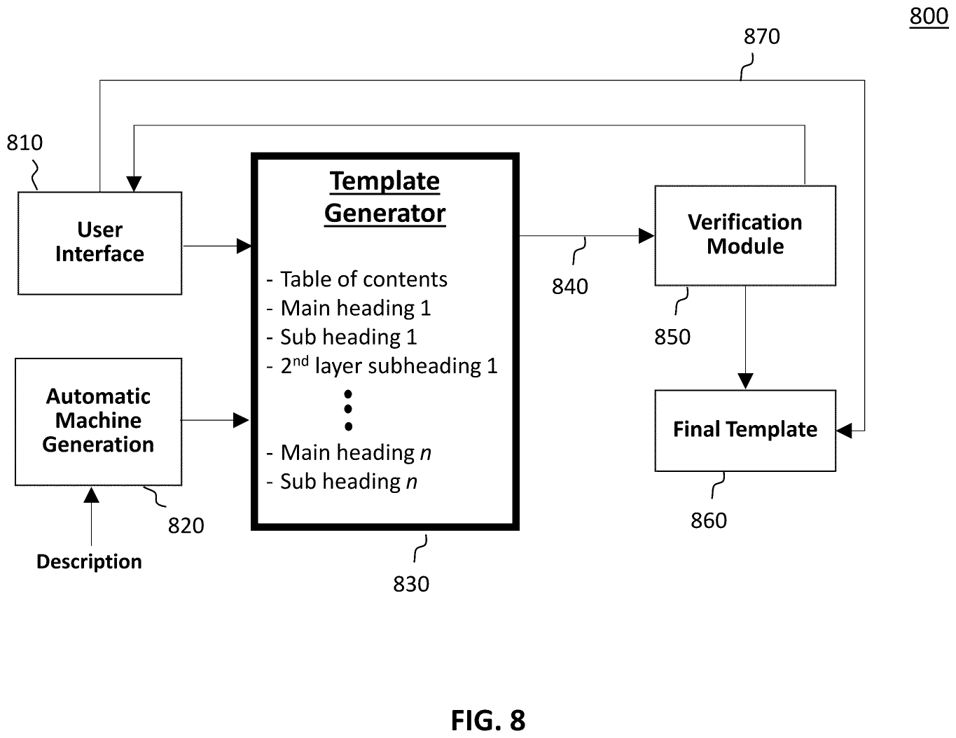

At block 150, once the request to generate a content item is received, whether by the user or suggested to the user for selection and then received, the control circuitry 220 and/or 228 may generate a template based on the received request. The template may include a hierarchy of sections or nodes in a document or a presentation. Some of the sections in the template may have multiple sub-sections and others may not. Which sections to create and how many layers of sub-sections to create for each topic in the template may be based on the type of document to be generated and user or system input. It may also be directed by an LLM suggestion provided. In some embodiments, the template may be received from a user interface of an electronic device associated with a user. In other embodiments, the template may be generated by the control circuitry 220 and/or 228 by querying the user interface associated with the user. The query may ask for certain information that may allow the control circuitry 220 and/or 228 to determine which type of template is to be generated. The control circuitry 220 and/or 228 may also display on the user interface of a user device associated with the user, various sections that can be used to upload documents that may assist the control circuitry 220 and/or 228 in determining which type of template to generate. In some embodiments, the process to generate a template is described further in FIGS. 8-11.

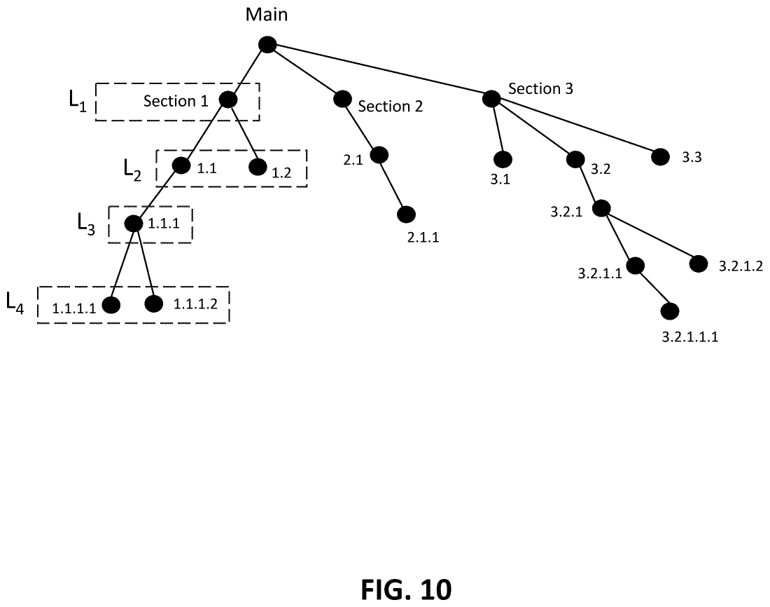

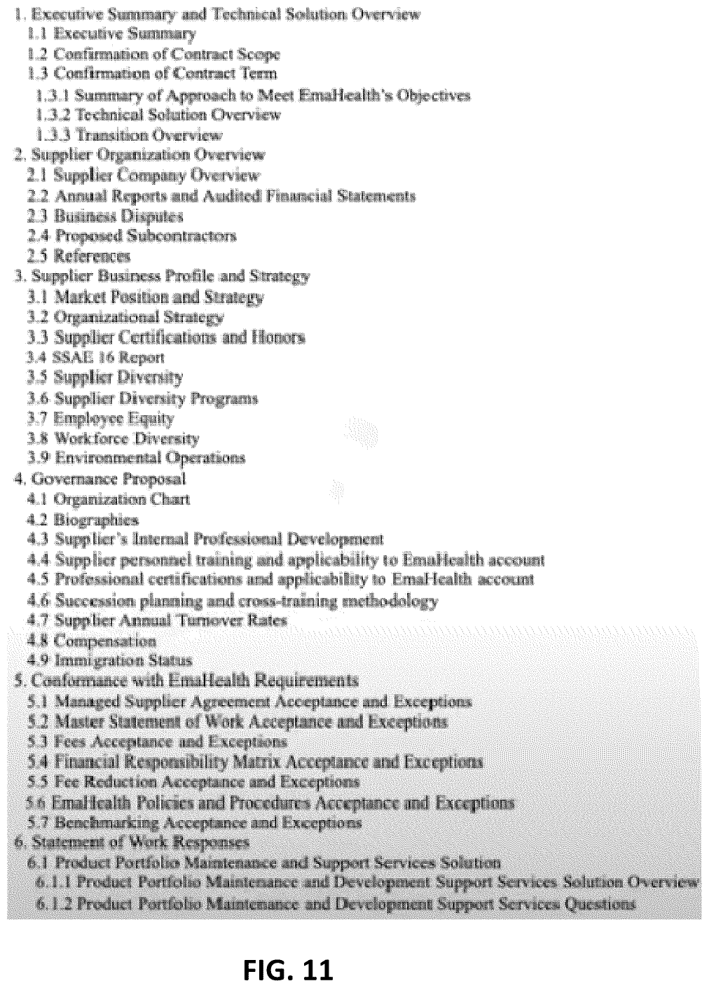

The generated template, as described earlier, may include sections and layers of subsections for each section. Some sections may have one layer (subsection), some may have several layers of nested subsections while others may not have any subsections at all. It may depend on the nature, type, context of the content item to be generated. It may also depend on the recommendation obtain from an LLM. Some examples of the nested forest and trees of sections and layers of subsections are depicted in FIGS. 10 and 11.

At block 155, a search query may be performed by the control circuitry 220 and/or 228 to the semantic graph to identify, access, and obtain content that can be populated in the generated template. In some embodiments, the search query may be performed for each section in the template. The querying process may start with the deepest nested leaf, which may also be referred to as the bottom most nested layer in all the sections (or a particular section), or the most fine-grained subsection. For example, if a document has two sections, Section 1 and Section 2, and Section 2 has the following nested subsections, 2.1, 2.2, and 2.1.1, then section 2.1.1 may be the deepest nested leaf/bottom most nested layer/most fine-grained subsection. As such, the first query may for such a deepest nested leaf/bottom most nested layer/most fine-grained subsection. The query may be to the generated semantic graph for identifying and determining content relevant to the deepest subsection. In some embodiments, an LLM may match the query to indexed data items in the semantic graph and suggest which indexed data is to be obtained and populated in the section for which the query was conducted.

At block 160, data in response to the query made may be obtained by the control circuitry 220 and/or 228. In some embodiments, the query to the semantic graph may result in the pointing to the data indexed at the data source where it is stored. If the user device querying such data has the allotted permissions and authorizations to obtain such data, then such data may be obtained at block 160 and be made available to a generation model (e.g., an LLM model) to perform a write operation at block 165.

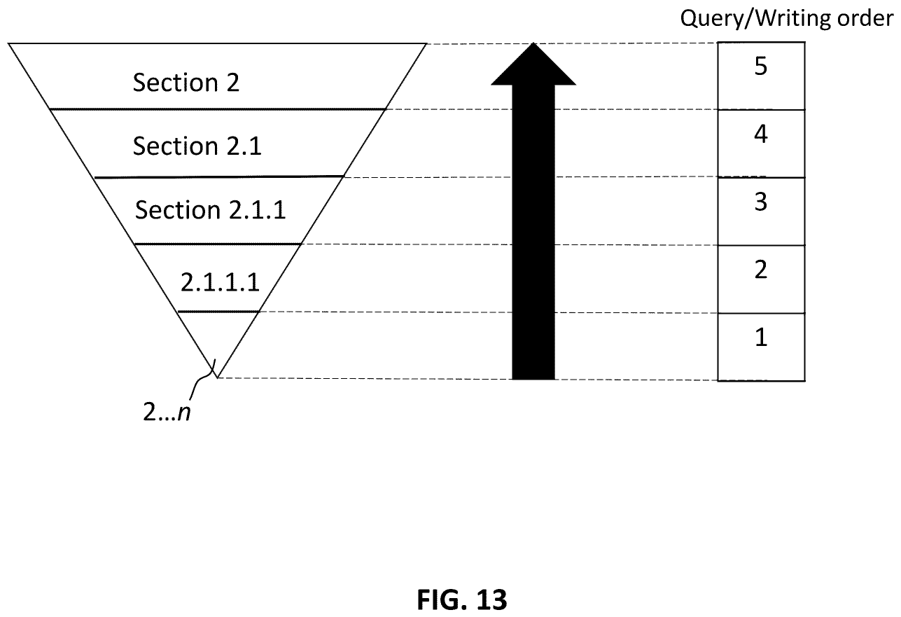

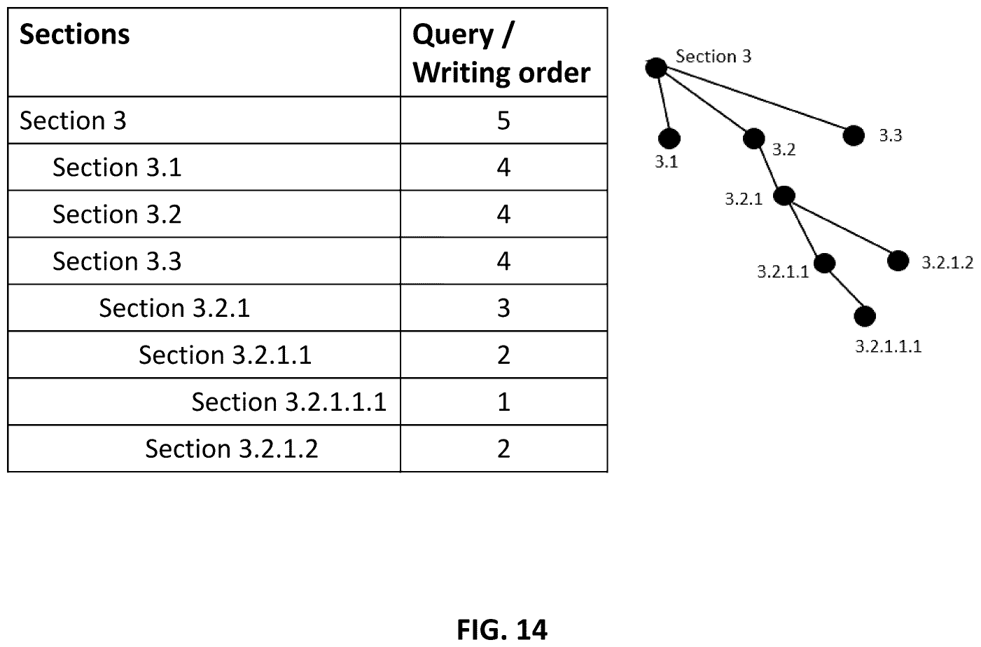

At block 165, a write operation may be performed to write the obtained data into the deepest or most fine-grained subsection. How to use the obtained data and write a logical and coherent section may be based on recommendations from an LLM model. The order of writing into the template may be based on the hierarchy of the sections, as described above with respect to the query. Some examples of the order of write operation, which mirrors the order of query, is depicted in FIGS. 13 and 14.

Once a write operation is performed, the user may provide any feedback at block 170. In some embodiments, a per-layer feedback may be provided by the user. Each per-layer feedback may result in regeneration of the subsection (or section) for which the feedback was provided as well as any other section or subsections in the template that refer to the regenerated section or depend on the regenerated section in any form. As such, all other sections may maintain data consistency for any change performed to the section for which feedback was provided.

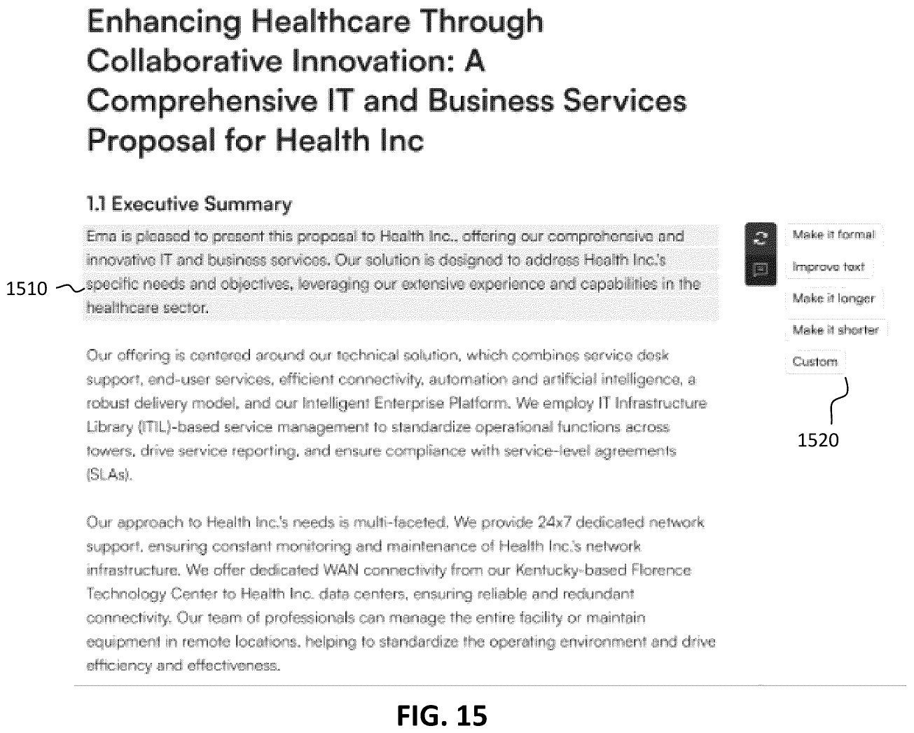

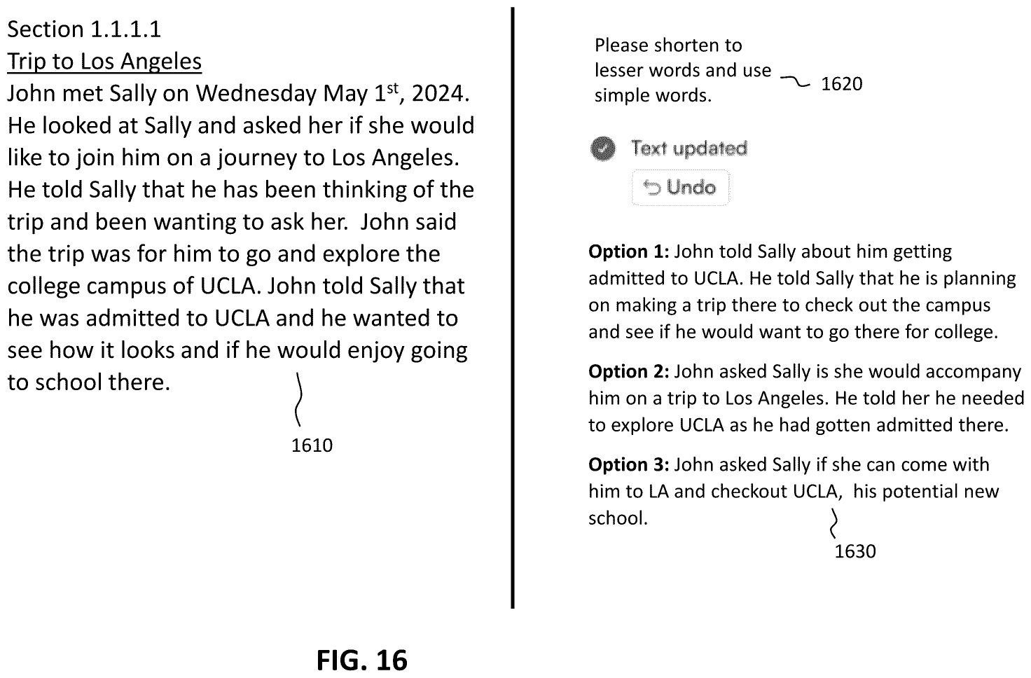

The process of providing feedback may include highlighting the section or subsection for which feedback is to be provided. The highlighting may be automatic if the user's mouse, trackpad, finger, touchscreen cursor, or another type of cursor hovers over the section or subsection. The highlighting for editing and providing feedback may visually distinguish the section or subsection from other sections and subsections for which feedback is not being currently provided. If a section or subsection is hovered upon, selected, or highlighted, then the control circuitry 220 and/or 228, in some embodiments, may automatically provide editing suggestions. In some embodiments, the automatically provided editing suggestions may be based on determining user's preferences, prior edits, and patterns using machine learning techniques. In other embodiments, the automatically provided editing suggestions may also be based on preferences of other colleagues or the enterprise accepted policies. Some examples of such editing suggestions are provided in FIGS. 15 and 16.

The process from blocks 155 to 170 may be repeated for all sections and subsections in the template until all sections and subsections in the template are written. When multiple sections are in the same layer, parallel processing may be performed in real time (barring any network latency) to simultaneously write multiple sections on the same layer at the same time.

FIG. 2 is a block diagram of an example of a system for generating a long form business content item using private enterprise data, in accordance with some embodiments of the disclosure and FIG. 3 is a block diagram of an example of an electronic device or user device for generating a long form business content item using private enterprise data, in accordance with some embodiments of the disclosure.

FIGS. 2 and 3 also describe exemplary devices, systems, servers, and related hardware that may be used to implement processes, functions, elements and components, and functionalities described in relation to FIGS. 1 and 4-16. Further, FIGS. 2 and 3 may also be used to generate semantic graph(s), generate a long form business content item using private enterprise data, detect user connections with data sources, such as private enterprise data sources connected via login, access data sources connected by the user devices, organize data sources on a user interface, such as by topic, genre, category of enterprise function (e.g., sales, accounting, HR, ticketing, etc.), generate a sematic graph for the data/data items accessed from the data sources, performing initial and subsequent synchronization of data between semantic graph, data pipelines, and data sources to ensure any changes in data are updated, generate associations between data items accessed from the data sources in the semantic graph, indexing data items in the semantic graphs where the indexes point to the data source at which each data item is stored, receive user input on the type of content item, such as a long form business content item to be generated, which includes but is not limited to documents, excel or other related computational files, presentations, slides, guides, etc., receive user input from the system, such as based on AI or ML recommendations, on the type of content item, such as a long form business content item to be generated, generating a template based on the user or system input received, the template being a table of contents in some embodiments, performing a search query for each of the nodes, sections, sub-sections, leaves of the template, determining the most fine-grained node, section, sub-section, leaf of the template, determining the most fine-grained node, section, sub-section, leaf of a particular section in the template, starting the search query with the determined most fine-grained node, section, sub-section, leaf of the template or a section within the template, searching the semantic graph for data items that are relevant to the search query, e.g., to the most fine-grained node, section, sub-section, leaf of the template, obtaining relevant data items based on the search query, such from the data sourced indexed in the semantic graph, performing a write operation in the template in the most fine-grained node, section, sub-section, leaf of the template, for which the search query was conducted, repeating the search queries for all sections, sub-sections, modes, leaves in the template until all sections and subsections are completed, parallel processing and simultaneously searching and writing to sections and subsections that are on a same layer/level, determining identity of the user, including determining user job titles and designations, user access to data sources, including which data sources are authorized to be accessed by the user, determining enterprise identify, customizing the templates and semantic graphs based on user identity, enterprise identity, or both, publishing the final content or section by section as it is written to a user interface of a user device, providing feedback and editing capabilities, the provided editing and feedback capabilities including allowing feedback using a per layer, section-by-section, or layer-by-layer approach, highlighting sections for feedback, dynamically updating the section and any other related sections based on the feedback, updating semantic graphs based on the feedback, and performing all the functions, steps, features, discussed herein.

In some embodiments, one or more parts of, or the entirety of system 200, may be configured as a system implementing various features, processes, functionalities and components of FIGS. 1 and 4-12. Although FIG. 2 shows a certain number of components, in various examples, system 200 may include fewer than the illustrated number of components and/or multiples of one or more of the illustrated number of components.

System 200 is shown to include a computing device 218, a server 202 and a communication network 214. The system may be a generative artificial intelligence system that uses AI bots and agents and that leverages one or more large language models (LLMs), neural networks, and other similar AI type systems. It is understood that while a single instance of a component may be shown and described relative to FIG. 2, additional instances of the component may be employed. For example, server 202 may include, or may be incorporated in, more than one server. Similarly, communication network 214 may include, or may be incorporated in, more than one communication network. Server 202 is shown communicatively coupled to computing device 218 through communication network 214. While not shown in FIG. 2, server 202 may be directly communicatively coupled to computing device 218, for example, in a system absent or bypassing communication network 214.

Communication network 214 may comprise one or more network systems, such as, without limitation, an internet, LAN, WIFI or other network systems suitable for audio processing applications. In some embodiments, system 200 excludes server 202, and functionality that would otherwise be implemented by server 202 is instead implemented by other components of system 200, such as one or more components of communication network 214. In still other embodiments, server 202 works in conjunction with one or more components of communication network 214 to implement certain functionality described herein in a distributed or cooperative manner. Similarly, in some embodiments, system 200 excludes computing device 218, and functionality that would otherwise be implemented by computing device 218 is instead implemented by other components of system 200, such as one or more components of communication network 214 or server 202 or a combination. In still other embodiments, computing device 218 works in conjunction with one or more components of communication network 214 or server 202 to implement certain functionality described herein in a distributed or cooperative manner.

Computing device 218 includes control circuitry 228, display 234 and input circuitry 216. Control circuitry 228 in turn includes transceiver circuitry 262, storage 238 and processing circuitry 240. In some embodiments, computing device 218 or control circuitry 228 may be configured as user device 300 of FIG. 3.

Server 202 includes control circuitry 220 and storage 224. Each of storages 224 and 238 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, solid state devices, quantum storage devices, or any other suitable fixed or removable storage devices, and/or any combination of the same. Each storage 224, 238 may be used to store various types of data (e.g., user login and connections with various data sources, templates, including all sections in the templates, hierarchy or sections and nodes in the template, semantic graphs and updates to semantic graphs, data sources organization structure, such as by genre, data indexed in semantic graphs, association between data items listed in the semantic graphs, data written into a section, feedback received, identity of person and their access authorizations and permissions, person's tasks and agenda, input from user or system as to type of content item to create, data related to employee job titles and designations, and NLP, ML, and AI algorithms). Non-volatile memory may also be used (e.g., to launch a boot-up routine and other instructions). Cloud-based storage may be used to supplement storages 224, 238 or instead of storages 224, 238. In some embodiments, data relating to user login and connections with various data sources, templates, including all sections in the templates, hierarchy or sections and nodes in the template, semantic graphs and updates to semantic graphs, data sources organization structure, such as by genre, data indexed in semantic graphs, association between data items listed in the semantic graphs, data written into a section, feedback received, identity of person and their access authorizations and permissions, person's tasks and agenda, input from user or system as to type of content item to create and NLP, ML, and AI algorithms, and data relating to all other processes and features described herein, may be recorded and stored in one or more of storages 212, 238.

In some embodiments, control circuitry 220 and/or 228 executes instructions for an application stored in memory (e.g., storage 224 and/or storage 238). Specifically, control circuitry 220 and/or 228 may be instructed by the application to perform the functions discussed herein. In some implementations, any action performed by control circuitry 220 and/or 228 may be based on instructions received from the application. For example, the application may be implemented as software or a set of executable instructions that may be stored in storage 224 and/or 238 and executed by control circuitry 220 and/or 228. In some embodiments, the application may be a client/server application where only a client application resides on computing device 218, and a server application resides on server 202.

The application may be implemented using any suitable architecture. For example, it may be a stand-alone application wholly implemented on computing device 218. In such an approach, instructions for the application are stored locally (e.g., in storage 238), and data for use by the application is downloaded on a periodic basis (e.g., from an out-of-band feed, from an internet resource, or using another suitable approach). Control circuitry 228 may retrieve instructions for the application from storage 238 and process the instructions to perform the functionality described herein. Based on the processed instructions, control circuitry 228 may determine a type of action to perform in response to input received from input circuitry 216 or from communication network 214. For example, in response determining that a user device has connected to a data source, or a plurality of data sources, such as by logging in, or that a user device is provided authorized access to a plurality of data sources, regardless of whether the user device has logged in to them, the system may automatically generate semantic graph(s) for all data/data items that are stored in the data sources to which the user device has connected or is authorized to connect. To accomplish this, in one embodiment, the control circuitry 228 may perform the steps of process described at least in any one or more of FIGS. 1 and 5 and all the steps and processes described in all the figures depicted herein.

In client/server-based embodiments, control circuitry 228 may include communication circuitry suitable for communicating with an application server (e.g., server 202) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 214). In another example of a client/server-based application, control circuitry 228 runs a web browser that interprets web pages provided by a remote server (e.g., server 202). For example, the remote server may store the instructions for the application in a storage device. The remote server may process the stored instructions using circuitry (e.g., control circuitry 228) and/or generate displays. Computing device 218 may receive the displays generated by the remote server and may display the content of the displays locally via display 234. This way, the processing of the instructions is performed remotely (e.g., by server 202) while the resulting displays, such as the display windows described elsewhere herein, are provided locally on computing device 218. Computing device 218 may receive inputs from the user via input circuitry 216 and transmit those inputs to the remote server for processing and generating the corresponding displays. Alternatively, computing device 218 may receive inputs from the user via input circuitry 216 and process and display the received inputs locally, by control circuitry 228 and display 234, respectively.

Server 202 and computing device 218 may transmit and receive data such as data relating to user login and connections with various data sources, templates, including all sections in the templates, hierarchy or sections and nodes in the template, semantic graphs and updates to semantic graphs, data sources organization structure, such as by genre, data indexed in semantic graphs, association between data items listed in the semantic graphs, data written into a section, feedback received, identity of person and their access authorizations and permissions, person's tasks and agenda, input from user or system as to type of content item to create, data related to employee job titles and designations, and NLP, ML, and AI algorithms.

Control circuitry 220, 228 may send and receive commands, requests, and other suitable data through communication network 214 using transceiver circuitry 260, 262, respectively. Control circuitry 220, 228 may communicate directly with each other using transceiver circuits 260, 262, respectively, avoiding communication network 214.

It is understood that computing device 218 is not limited to the embodiments and methods shown and described herein. In nonlimiting examples, computing device 218 may be a personal computer (PC), a laptop computer, a tablet computer, a personal computer, a generative AI server, a handheld computer, a mobile telephone, a smartphone, or any other device, computing equipment, or wireless device, and/or combination thereof that can receive user device inputs related to generating long form content items, generating semantic graphs by using LLMs, generating templates, and writing into templates by data obtained through querying semantic graphs as discussed herein.

Control circuitry 220 and/or 218 may be based on any suitable processing circuitry such as processing circuitry 226 and/or 240, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors or Nvidia processors) or multiple different processors (e.g., an Intel Core i7 and i9 processors or Nvidia GH 100, 200).

In some embodiments, control circuitry 220 and/or control circuitry 218 are configured to generate semantic graph(s), generate a long form business content item using private enterprise data, detect user connections with data sources, such as private enterprise data sources connected via login, access data sources connected by the user devices, organize data sources on a user interface, such as by topic, genre, category of enterprise function (e.g., sales, accounting, HR, ticketing, etc.), generate a sematic graph for the data/data items accessed from the data sources, performing initial and subsequent synchronization of data between semantic graph, data pipelines, and data sources to ensure any changes in data are updated, generate associations between data items accessed from the data sources in the semantic graph, indexing data items in the semantic graphs where the indexes point to the data source at which each data item is stored, receive user input on the type of content item, such as a long form business content item to be generated, which includes but is not limited to documents, excel or other related computational files, presentations, slides, guides, etc., receive user input from the system, such as based on AI or ML recommendations, on the type of content item, such as a long form business content item to be generated, generating a template based on the user or system input received, the template being a table of contents in some embodiments, performing a search query for each of the nodes, sections, sub-sections, leaves of the template, determining the most fine-grained node, section, sub-section, leaf of the template, determining the most fine-grained node, section, sub-section, leaf of a particular section in the template, starting the search query with the determined most fine-grained node, section, sub-section, leaf of the template or a section within the template, searching the semantic graph for data items that are relevant to the search query, e.g., to the most fine-grained node, section, sub-section, leaf of the template, obtaining relevant data items based on the search query, such from the data sourced indexed in the semantic graph, performing a write operation in the template in the most fine-grained node, section, sub-section, leaf of the template, for which the search query was conducted, repeating the search queries for all sections, sub-sections, modes, leaves in the template until all sections and subsections are completed, parallel processing and simultaneously searching and writing to sections and subsections that are on a same layer/level, determining identity of the user, including determining user job titles and designations, user access to data sources, including which data sources are authorized to be accessed by the user, determining enterprise identify, customizing the templates and semantic graphs based on user identity, enterprise identity, or both, publishing the final content or section by section as it is written to a user interface of a user device, providing feedback and editing capabilities, the provided editing and feedback capabilities including allowing feedback using a per layer, section-by-section, or layer-by-layer approach, highlighting sections for feedback, dynamically updating the section and any other related sections based on the feedback, updating semantic graphs based on the feedback, and perform all the functions, steps, features, discussed herein. Control circuitry 220 and/or control circuitry 218 are also configured to perform all processes described and shown in connection with FIGS. 1, 5, 8, and 12.

Computing device 218 receives a user input 204 at input circuitry 216. For example, computing device 218 may receive a user input like 710, 730, and/or 740 in FIG. 7, which may be a request to generate a long form content item.

Transmission of user input 204 to computing device 218 may be accomplished using a wired connection, such as an audio cable, USB cable, ethernet cable or the like attached to a corresponding input port at a local device, or may be accomplished using a wireless connection, such as Bluetooth, WIFI, WiMAX, GSM, UTMS, CDMA, TDMA, 3G, 4G, 4G LTE, 5G (or 6G which is in development) or any other suitable wireless transmission protocol. Input circuitry 216 may comprise a physical input port such as a 3.5 mm audio jack, RCA audio jack, USB port, ethernet port, or any other suitable connection for receiving audio over a wired connection or may comprise a wireless receiver configured to receive data via Bluetooth, WIFI, WiMAX, GSM, UTMS, CDMA, TDMA, 3G, 4G, 4G LTE, 5G (or 6G which is in development), or other wireless transmission protocols.

Processing circuitry 240 may receive input 204 from input circuit 216. Processing circuitry 240 may convert or translate the received user input 204 that may be in the form of voice input into a microphone. In some embodiments, input circuit 216 performs the translation to digital signals. In some embodiments, processing circuitry 240 (or processing circuitry 226, as the case may be) carries out disclosed processes and methods. For example, processing circuitry 240 or processing circuitry 226 may perform processes as described in FIGS. 1, 5, 8, and 12 respectively.

FIG. 3 is a block diagram of an example of an electronic device 300 or user device for generating a long form business content item using private enterprise data, in accordance with some embodiments of the disclosure. FIG. 3 is also used to generate semantic graph(s), generate a long form business content item using private enterprise data, detect user connections with data sources, such as private enterprise data sources connected via login, access data sources connected by the user devices, organize data sources on a user interface, such as by topic, genre, category of enterprise function (e.g., sales, accounting, HR, ticketing, etc.), generate a sematic graph for the data/data items accessed from the data sources, performing initial and subsequent synchronization of data between semantic graph, data pipelines, and data sources to ensure any changes in data are updated, generate associations between data items accessed from the data sources in the semantic graph, indexing data items in the semantic graphs where the indexes point to the data source at which each data item is stored, receive user input on the type of content item, such as a long form business content item to be generated, which includes but is not limited to documents, excel or other related computational files, presentations, slides, guides, etc., receive user input from the system, such as based on AI or ML recommendations, on the type of content item, such as a long form business content item to be generated, generating a template based on the user or system input received, the template being a table of contents in some embodiments, performing a search query for each of the nodes, sections, sub-sections, leaves of the template, determining the most fine-grained node, section, sub-section, leaf of the template, determining the most fine-grained node, section, sub-section, leaf of a particular section in the template, starting the search query with the determined most fine-grained node, section, sub-section, leaf of the template or a section within the template, searching the semantic graph for data items that are relevant to the search query, e.g., to the most fine-grained node, section, sub-section, leaf of the template, obtaining relevant data items based on the search query, such from the data sourced indexed in the semantic graph, performing a write operation in the template in the most fine-grained node, section, sub-section, leaf of the template, for which the search query was conducted, repeating the search queries for all sections, sub-sections, modes, leaves in the template until all sections and subsections are completed, parallel processing and simultaneously searching and writing to sections and subsections that are on a same layer/level, determining identity of the user, including determining user job titles and designations, user access to data sources, including which data sources are authorized to be accessed by the user, determining enterprise identify, customizing the templates and semantic graphs based on user identity, enterprise identity, or both, publishing the final content or section by section as it is written to a user interface of a user device, providing feedback and editing capabilities, the provided editing and feedback capabilities including allowing feedback using a per layer, section-by-section, or layer-by-layer approach, highlighting sections for feedback, dynamically updating the section and any other related sections based on the feedback, updating semantic graphs based on the feedback, and performing all the functions, steps, features, discussed herein.

In an embodiment, the equipment device 300, is the same equipment device 202 of FIG. 2. The equipment device 300 may receive content and data via input/output (I/O) path 302. The I/O path 302 may provide audio content and data to control circuitry 304, which includes processing circuitry 306 and a storage 308. The control circuitry 304 may be used to send and receive commands, requests, and other suitable data using the I/O path 302. The I/O path 302 may connect the control circuitry 304 (and specifically the processing circuitry 306) to one or more communications paths. I/O functions may be provided by one or more of these communications paths but are shown as a single path in FIG. 3 to avoid overcomplicating the drawing.

The control circuitry 304 may be based on any suitable processing circuitry such as the processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 or Nvidia processors) or multiple different processors (e.g., an Intel Core i5, i7, i9 processor, Nvidia GH 100, 200).

The processes as described herein may be implemented in or supported by any suitable software, hardware, or combination thereof. They may also be implemented on user equipment, on remote servers, or across both.

In client-server-based embodiments, the control circuitry 304 may include communications circuitry suitable to generate semantic graph(s), generate a long form business content item using private enterprise data, detect user connections with data sources, such as private enterprise data sources connected via login, access data sources connected by the user devices, organize data sources on a user interface, such as by topic, genre, category of enterprise function (e.g., sales, accounting, HR, ticketing, etc.), generate a sematic graph for the data/data items accessed from the data sources, performing initial and subsequent synchronization of data between semantic graph, data pipelines, and data sources to ensure any changes in data are updated, generate associations between data items accessed from the data sources in the semantic graph, indexing data items in the semantic graphs where the indexes point to the data source at which each data item is stored, receive user input on the type of content item, such as a long form business content item to be generated, which includes but is not limited to documents, excel or other related computational files, presentations, slides, guides, etc., receive user input from the system, such as based on AI or ML recommendations, on the type of content item, such as a long form business content item to be generated, generating a template based on the user or system input received, the template being a table of contents in some embodiments, performing a search query for each of the nodes, sections, sub-sections, leaves of the template, determining the most fine-grained node, section, sub-section, leaf of the template, determining the most fine-grained node, section, sub-section, leaf of a particular section in the template, starting the search query with the determined most fine-grained node, section, sub-section, leaf of the template or a section within the template, searching the semantic graph for data items that are relevant to the search query, e.g., to the most fine-grained node, section, sub-section, leaf of the template, obtaining relevant data items based on the search query, such from the data sourced indexed in the semantic graph, performing a write operation in the template in the most fine-grained node, section, sub-section, leaf of the template, for which the search query was conducted, repeating the search queries for all sections, sub-sections, modes, leaves in the template until all sections and subsections are completed, parallel processing and simultaneously searching and writing to sections and subsections that are on a same layer/level, determining identity of the user, including determining user job titles and designations, user access to data sources, including which data sources are authorized to be accessed by the user, determining enterprise identify, customizing the templates and semantic graphs based on user identity, enterprise identity, or both, publishing the final content or section by section as it is written to a user interface of a user device, providing feedback and editing capabilities, the provided editing and feedback capabilities including allowing feedback using a per layer, section-by-section, or layer-by-layer approach, highlighting sections for feedback, dynamically updating the section and any other related sections based on the feedback, updating semantic graphs based on the feedback, and performing all the functions, steps, features, discussed herein. The instructions for carrying out the above-mentioned functionality may be stored on one or more servers. Communications circuitry may include a cable modem, an integrated service digital network (ISDN) modem, a digital subscriber line (DSL) modem, a telephone modem, ethernet card, or a wireless modem for communications with other equipment, or any other suitable communications circuitry. Such communications may involve the internet or any other suitable communications networks or paths. In addition, communications circuitry may include circuitry that enables peer-to-peer communication of electronic equipment devices, or communication of electronic equipment devices in locations remote from each other (described in more detail below).

Memory may be an electronic storage device provided as the storage 308 that is part of the control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum-storage devices, or any other suitable fixed or removable storage devices, and/or any combination of the same. The storage 308 may be used to store user login and connections with various data sources, templates, including all sections in the templates, hierarchy or sections and nodes in the template, semantic graphs and updates to semantic graphs, data sources organization structure, such as by genre, data indexed in semantic graphs, association between data items listed in the semantic graphs, data written into a section, feedback received, identity of person and their access authorizations and permissions, person's tasks and agenda, input from user or system as to type of content item to create, data related to employee job titles and designations, and NLP, ML, and AI algorithms. Cloud-based storage, described in relation to FIG. 3, may be used to supplement the storage 308 or instead of the storage 308.

The control circuitry 304 may include audio generating circuitry and tuning circuitry, such as one or more analog tuners, audio generation circuitry, filters or any other suitable tuning or audio circuits or combinations of such circuits. The control circuitry 304 may also include scaler circuitry for upconverting and down converting content into the preferred output format of the electronic device 300. The control circuitry 304 may also include digital-to-analog converter circuitry and analog-to-digital converter circuitry for converting between digital and analog signals. The tuning and encoding circuitry may be used by the electronic device 300 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 308 is provided as a separate device from the electronic device 300, the tuning and encoding circuitry (including multiple tuners) may be associated with the storage 308.

The user may utter instructions to the control circuitry 304, which are received by the microphone 316. The microphone 316 may be any microphone (or microphones) capable of detecting human speech. The microphone 316 is connected to the processing circuitry 306 to transmit detected voice commands and other speech thereto for processing. In some embodiments, voice assistants (e.g., Siri, Alexa, Google Home and similar such voice assistants) receive and process the voice commands and other speech.

The electronic device 300 may include an interface 310. The interface 310 may be any suitable user interface, such as a remote control, mouse, trackball, keypad, keyboard, touch screen, touchpad, stylus input, joystick, or other user input interfaces. A display 312 may be provided as a stand-alone device or integrated with other elements of the electronic device 300. For example, the display 312 may be a touchscreen or touch-sensitive display. In such circumstances, the interface 310 may be integrated with or combined with the microphone 316. When the interface 310 is configured with a screen, such a screen may be one or more monitors, a television, a liquid crystal display (LCD) for a mobile device, active-matrix display, cathode-ray tube display, light-emitting diode display, organic light-emitting diode display, quantum-dot display, or any other suitable equipment for displaying visual images. In some embodiments, the display 312 may be a 3D display. The speaker (or speakers) 314 may be provided as integrated with other elements of electronic device 300 or may be a stand-alone unit. In some embodiments, the display 312 may be outputted through speaker 314.

The equipment device 300 of FIG. 3 can be implemented in system 200 of FIG. 2 as electronic equipment device 202, but any other type of user equipment suitable for allowing communications between two separate user devices for performing the functions related to implementing machine learning (ML) and artificial intelligence (AI) algorithms, and all the functionalities discussed associated with the figures mentioned in this application

The electronic device 300 of any other type of suitable user equipment suitable may also be used to implement ML and AI algorithms, and related functions and processes as described herein. Various network configurations of devices may be implemented and are discussed in more detail below.

FIG. 4 is a block diagram of an example of private enterprise data organized by genre, topic, or any desired category, in accordance with some embodiments of the disclosure. In some embodiments, a user may connect, such as by logging in, to a plurality of databases, files, libraries, and applications. For example, the user may connect to their accounting applications, HR applications, ticketing applications, E-mail, sales applications, or to their text messaging applications. The user may also connect to any other system within the enterprise that holds private enterprise data. As depicted in FIG. 4, in one embodiment, the user may have connected to applications such as Box, QuickBooks Online, Salesforce, Zendex, Dropbox, Google Drive, Free Agent, FreshBooks, Work Day, Asana, and NetSuite. The user may have also connected to their email (both work and/or personal) and their text messaging applications, such as WhatsApp, Facebook messenger, or other communications applications such as Slack.

In one embodiment, when the user connects to any such databases and applications, such as by logging in, the control circuitry 220 and/or 228 may automatically access all such applications. The control circuitry 220 and/or 228 may then obtain data from the accessed databases and applications and generate a sematic graph that provides associations and relationships between all the data obtained. In some embodiments, the process of obtaining data may also involve obtaining file file-names, metadata, timestamps. It may also involve getting file names from previous conversations, such as conversation mentioned in emails or text from the user device, since the system is provided access to all communications, or in some embodiments only enterprise related communications like company email, from where such files names and associated data sources may be identified. In some embodiments, the control circuitry 220 and/or 228, instead of obtaining the data, may analyze the data to generate the semantic graph and index the semantic graph such that the indexed data can be obtained as needed, such as when queried.

In another embodiment, the control circuitry 220 and/or 228 may determine which data sources are authorized/permitted for the user device to connect to, such as via logging in. Even if the user has not actually logged into such data sources, as long as the user device is authorized and permitted to access data from them, such data sources may also be used by the control circuitry 220 and/or 228 to access or obtain data from the accessed databases and applications and generate a sematic graph that provides associations and relationships between all the data accesses and/or obtained.

In other embodiments, the control circuitry 220 and/or 228 may suggest to the user to connect to a certain account or application based on the type of content item that is to be created. For example, control circuitry 220 and/or 228 may determine that a request for proposal (RFP) is to be created by the user. The control circuitry 220 and/or 228 may make such a determination based on emails received by the user from a colleague or their boss. The control circuitry 220 and/or 228 may also crawl or spider a plurality of enterprise and private communication tools and databases and analyze user communications and tasks (e.g., emails, text, Slack messages, meeting minutes, etc.) to determine what task is to be performed by the user device. The control circuitry 220 and/or 228 may also determine that data that may be relevant to the task is stored in a particular database or application that the user is authorized to access. Accordingly, the control circuitry 220 and/or 228 may suggest the user to connect (e.g., log in) to the particular database or application that stores the data that may be relevant to the task. In another embodiment, if the control circuitry 220 and/or 228 determines that the user device is authorized to access the particular database or application that stored the data that may be relevant to the task, then the control circuitry 220 and/or 228 may automatically access and/or obtain the data from the particular database or application regardless of whether the user connects to it.

In some embodiments, the control circuitry 220 and/or 228 may display all the accounts or databases to which the user has authorized access on a user interface of an electronic device used by the user as depicted in FIG. 4. The control circuitry 220 and/or 228 may also generate headers and titles for different categories under which the access to the different applications and databases may be listed. The control circuitry 220 and/or 228 may leverage an LLM to determine the headers and titles for the groups of application icons clustered together in a group. The display on the user interface may be organized by genre, such as by the topic or category of the application, such as all ticketing applications may be displayed under a ticketing header.

FIG. 5 is flowchart of an example of a process 500 for generating a semantic graph that represents data from data sources and file storage, in accordance with some embodiments of the disclosure. Process 500, in some embodiments, may be implemented, in whole or in part, by systems or devices such as those shown in FIGS. 2-3. One or more actions of the process 500 may be incorporated into or combined with one or more actions of any other process or embodiments described herein. The process 500 may be saved to a memory or storage (e.g., any one of those depicted in FIGS. 2-3) as one or more instructions or routines that may be executed by a corresponding device or system to implement the method 500.

In some embodiments, the elements of the process may include a file storage 510, user connections 520, permissions 530, data pipelines 535, semantic graph 540, and updating or adding to the semantic graph 545.

In some embodiments, the process 500 may be initiated when a user 520 connects to a file storage 510. In other words, the process may be initiated when a user logs in to any of the databases or applications to which they have authorized access. In some embodiments, the control circuitry 220 and/or 228 may check for permissions and authorizations to ensure that the user can access all the data in the file storage. For example, there may be instances where the user is authorized to access a portion of the database and not all of the files in the database. This may be because certain private data in the database may either require another password or higher level of access to which the user is not authorized. As such, the control circuitry 220 and/or 228 may determine permissions 530 for each application and database to which the user connects to ensure that only data that is authorized to be accessible by the user can be used in generating the semantic graph.

Once the user connection and permissions have been evaluated, a plurality of data pipelines 535 are triggered. These data pipelines 535 are triggered for each connection/login. For example, if a user logs into the sales application, the associated data pipeline may be triggered. Likewise, if the user logs into a ticketing application, another associated data pipeline may be triggered. Accordingly, for each application connected, a separate data pipeline may be triggered. In some embodiments, all the separate data pipelines may be collectively aggregated into a larger data pipeline. In an alternative embodiment, a single data pipeline, instead of separate data pipelines, maybe used to manage the flow of data and updates. In another embodiments, once it is determined that the user has authorized access to the data items from the plurality of data sources, regardless of whether the user connects to them, as long as the user is permitted and authorized access, the plurality of data pipelines 535 may be triggered.

The data pipelines 535 may be used to perform an initial sync of data with the associated file storage. In this initial sync, the data pipelines may query the file storage to provide all the file data. Subsequently after the initial sync, if any of the applications has an update, or any of the data items from any of the data sources are updated, deleted, or added, then such asynchronous updates, deletion, and additions may be provided to the data pipelines in real time, subject to any network latency. The update may be, for example, a portion of an application, a portion of data, a table, a comment, etc. It may be a small update or large update where a lot of data is changed. When the update is to a portion of the data in an application, then only the portion that has changed in the application may be changed in the semantic graph. Such updates by portions, segments, or even to even small piece of data, such as a table, being made only to the relevant portion in the semantic graph may save computing resources that would otherwise be required to regenerate the entire data. In some embodiments, when a data item in any of the applications or database in the file storage 510 goes through a change, the change is transmitted at 580 to the data pipelines, such as the data pipeline associated with the application which underwent the data change. The data is the resynchronized and any related update is made to the semantic graph. In some embodiment, if multiple queries are done for same sub-section, the system may add cache for search results for the same query and perform filtering such that they can be used in a subsequent query.

In one example, after the initial synchronization of data via steps 550 and 560, a semantic graph may be created. If any data is changed, such as in the ticketing application (or any other application to which the user has connected), or new data is added (e.g., a new document in HR policy), such asynchronous update in the data may be transmitted to the data pipelines at step 580. The data pipeline may then process and transmit the change to update the semantic graph at 590. As described earlier, only data that is changed in the application will be updated on the semantic graph. If that data is used in multiple places in the semantic graph, or if other data depends on the changed data, then all data that relies on the data that is changed may also be changed for consistency. The control circuitry 220 and/or 228 may understand exactly where the change in data effects the semantic graph and accordingly make the updates to the semantic graph with the newly updated data.

In some embodiments, the process of FIG. 5 may also include, in addition to or in lieu of the process described, extracting a token from the query, such as the query for each sub-section or paragraph to the semantic graph. This may be performed for identifying data contract and web search policy concept in the query or to identify name entity recognition (NER), such as that of the user or the enterprise. The process may also include performing a metadata search, this may be to get all data contract file names (all files uploaded in the data sources). The system may then identify documents uploaded. It may use backend logic to understand how to query these documents ad which documents are uploaded. It may tag these documents and use the tags as needed. The system may perform pos-processing rules to transform to extract rules into a standardized format. It may obtain relevant docs for rules and docs being validated. It may use vertex-based retrieval of relevant documents based on tokens identified in the queries. It may then validate rules with docs being validated, such as by performing an LLM call.

When documents are uploaded by a user in connection with requesting a long form content item, such as an RFP or another type of document that the user would like the system to use as input in generating a template, then, in some embodiments, the system may use hardcoded URLs of documents to get RFP overview and structured requirement documents. It may then use prompts to create template hardcoded for the RFP to be created, e.g. “Company XYZ RFP.” The system may then generate a template and query the semantic graph sequentially based on sections of template, such as by using the bottoms up approach described herein. The system may create search queries based on RFP and structured requirement documents. It may use the search queries in the pinecone databases in-memory index. It may get the search response and use LLM to format the response and then concatenate the responses generated.

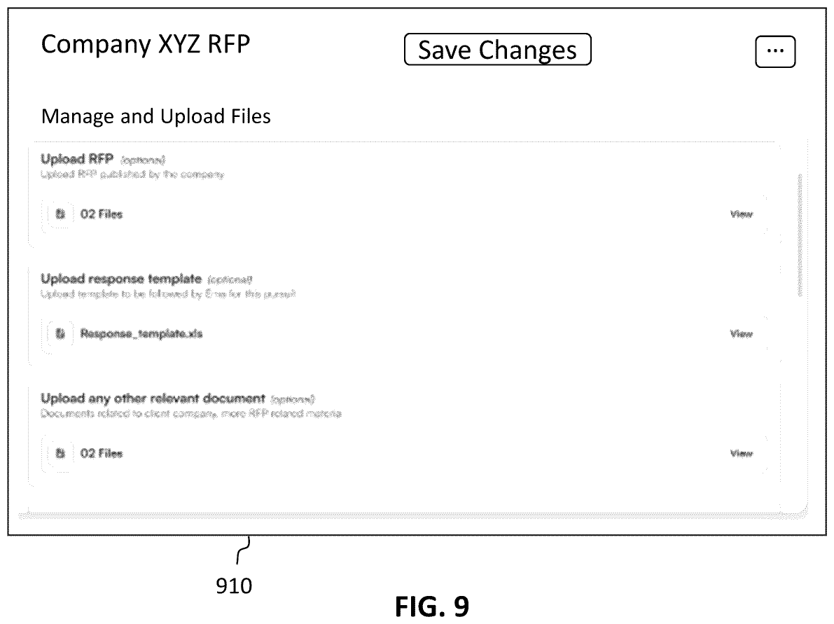

FIG. 6 is a block diagram of user requests and suggested user requests for generating a long form business content item, in accordance with some embodiments of the disclosure. Referring to block 145 of FIG. 1, the process to generate a large business document or presentation using private enterprise data may be originated by a user, as depicted at 610, or by the system 620, such as the system in FIG. 2. When the request is originated by the user, the user, via their user interface, may provide any type of details relating to the type of document, style of the document, context of the document, etc. In other embodiments, in their request, the user may provide a high-level framework of the type of document to generate. Some examples of the type of user requests are provided in FIG. 7. For example, the user may request, as depicted at 710 in FIG. 7, “Can you generate a proposal document which tells about the Enhancing Healthcare Through Collaborative Innovation: A Comprehensive IT and Business Services Proposal for Health Inc.” In another example, the user may request, as depicted at 730 in FIG. 7, “Can you create an employee handbook for our company ABC, Inc. Make sure it includes sections on vacations, benefits, and topics that concern our company.” In yet another example, the user may request, as depicted at 740 in FIG. 7, “Can you generate a presentation for a marketing pitch to XYZ Corp. Make sure it thorough and highlights our major achievement.” The control circuitry 220 and/or 228, in some embodiments, also ask follow up questions or request documents to be uploaded to further understand the scope of the request, one such example of a user interface generated by the control circuitry 220 and/or 228 for the follow-up is depicted at FIG. 9.

In another embodiment, the request to generate a content item, such as a large business document or presentation using private enterprise data, may be originated by the system, as depicted at 620. In this embodiment, the control circuitry 220 and/or 228 may monitor the user's communications, user's tasks, action items from meeting minutes, or a voice message received by the user from in their voicemail. Since the control circuitry 220 and/or 228 may have access, or be provided access, to all such data communications and sources, it may use an LLM to input the data received and determine what documents, presentations, and content items are to be generated by the user. The control circuitry 220 and/or 228 may also leverage machine learning data 630 to determine user patterns and what documents need to be generated, e.g. the control circuitry may determine that its currently the month of December and based on user pattern, the user usually generates an annual report at this time. The control circuitry 220 and/or 228 may also determine what documents are to be generated based on the user's job function 640 or assigned tasks 650. The control circuitry 220 and/or 228 may also determine from the LLM, what information is needed to generate such a document. Based on such information, the control circuitry 220 and/or 228 may provide the recommendation for the user's selection on what documents are to be generated. If the user approves the selection, then the processes of FIGS. 1, 5, 8, and 10 may be activated to generate the document requested. The document may then be generated in real time, subject to any network latency. As depicted in FIG. 7, in one example, the long form business document 720, which may be of a large length, such as 20, 50, 100, 500, 2000 pages or more, may be generated in real time or within seconds of receiving the user request 710 by using an LLM to leverage a semantic graph and coherently populate a template.

FIG. 8 is flowchart of an example of a process 800 for generating a template that is to be populated with content, such as private enterprise data, to generate the long form business content item, in accordance with some embodiments of the disclosure. Process 800 may be implemented, in whole or in part, by systems or devices such as those shown in FIGS. 2-3. One or more actions of the process 800 may be incorporated into or combined with one or more actions of any other process or embodiments described herein. The process 800 may be saved to a memory or storage (e.g., any one of those depicted in FIGS. 2-3) as one or more instructions or routines that may be executed by a corresponding device or system to implement the method 800. The process may include generating a template using an LLM. The template may then be populated by querying the semantic graph for data.

In some embodiments, a user interface 820, associated with the user making a request to generate a content item, may provide the template to the template generator 830. In other embodiments, the template may be automatically machine generated 820 based on description received from the user interface 810, an LLM recommendation, or other sources.

If the user provided template is determined to be complete, then the process may move to block 860 where the final template may be generated. However, if a determination is made that the user provided template is either incomplete or can be further enhanced, then the template generator 830 may analyze the user provided template and edit or update the template as needed. A determination of whether the template is incomplete or can be further enhanced may be based on results from an LLM when the template is used an input to obtain an answer. At 840, once the template is generated by the template generator 830, it may be verified using verification module 850.

In the embodiments where the template is automatically machine generated 820, it may be generated based on description received from the user or other sources. For example, a query may be made to the user requesting information that can be used in automatically generating the template. An example of such query, which may ask the user to upload a document, is provided in FIG. 9. Other targeted queries, which may ask the user, what content item is to be generated, what is the use case for the content item, what formatting should be used for the content item, and other such relevant queries may be made. Although, in this embodiment, the template is automatically generated with little or no user input, the system may still iteratively query the user to obtain key information needed to generate the template.

The template generator 830 may generate the template, which includes a table of contents with a plurality of headings and subheadings for each section and subsection in the table of contents. One example of a template that includes nested layers of sections and subsections is depicted in FIG. 10. The template may also be a questionnaire with a list of questions being asked to the semantic graph, which acts as a knowledge base.

Once the template is generated it may be transmitted, as depicted as 840, to a verification module at 850. The verification module 850 may communicate with the user interface (or a user device associated with the user) to determine whether the generated template requires any changes. The user, via the user interface 810, may provide their changes on a layer by layer or a section by section or subsection by subsection basis. Once the verification is completed, a final template may be generated at 860.

FIG. 9 is an example of a user interface for providing information that may be used to generate the template, in accordance with some embodiments of the disclosure. In some embodiments, the user interface may display a query 910 or a query form. The query 910 may include different sections for the user to upload. Documents such as an RFP or other relevant documents that may be used by the system in generating may be uploaded using the document upload section. The user interface may also be generated for the user, or the system, to add any type of detail or information that is to be considered in generating the long form business content item.

In some embodiments, the system may also ask a specific question to the user in the query. The answer to the specific question may then be factored in when generating the template. Although a few examples of different sections are shown in this query, the embodiments are not so limited and other types of queries may also be made using the query form. For example, in some embodiments, the system may query the user and provide suggested answers for the user's selection. The user selection of the suggested answers may be factored in when generating the template.

FIG. 10 is an example of layers or tiers of sections and their hierarchy in the generated template, in accordance with some embodiments of the disclosure. The template generated, such as by the process described in FIG. 8, an example of which is depicted in FIG. 11, may include a nested layers of sections and subsections. The template itself may be editable and include a table of contents with a plurality of headings and subheadings for the nested sections and subsections.

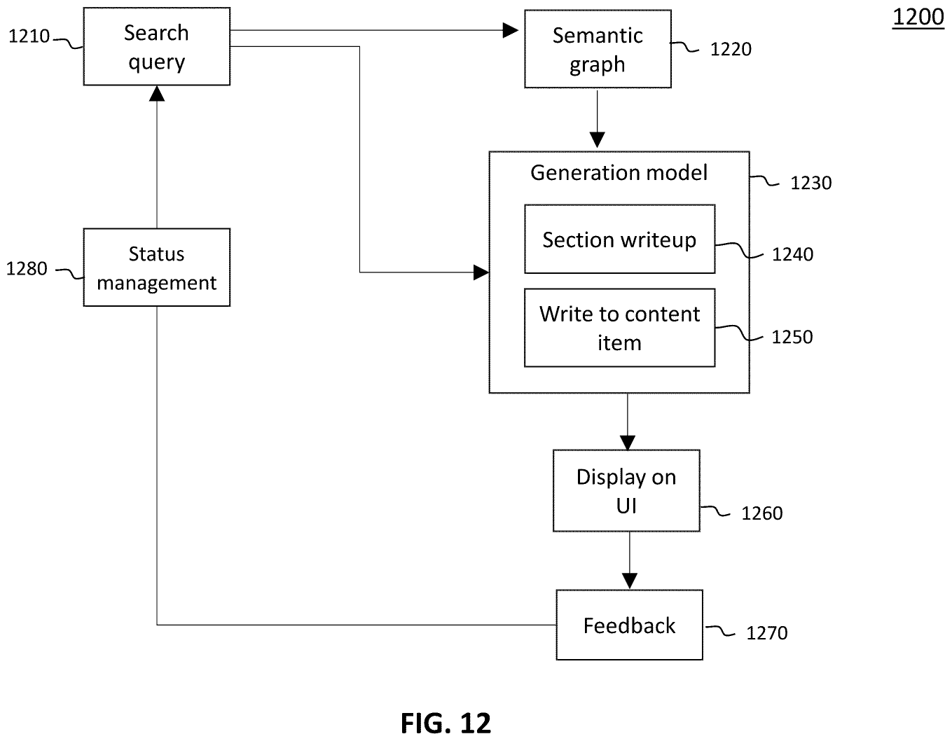

In some embodiment, as depicted in FIG. 10, a section, such as Section 1, may include Layers 2-4 of nested subsections. Section 1 itself may be in layer 1 while subsections 1.1 and 1.2 may be in layer 2, subsection 1.1.1 may be in layer 3, and subsection 1.1.1.1 and 1.1.1.2 may be in layer 4. Such layering hierarchy may be used in determining which section is to be written first. In some embodiments, the hierarchy may be used to write in a section using a bottom-up approach. This approach may include determining the deepest layer in the section, which in the case of Section 1 may be layer 4, and writing content to it first before the other sections. Additional details of the write operation are described in relation to FIGS. 12-14.

FIG. 11 is an example of a generated template, in accordance with some embodiments of the disclosure. As depicted, the generated template includes a plurality of sections and subsection that are nested underneath each other. Which sections to create and how many layers of nested sub-sections to create for a content item may be based on the type of content item to be generated, the data available through the semantic graph, user or system input, or LLM guidance provided.

In some embodiments, the control circuitry 220 and/or 228 may use an LLM to determine which sections to create and how many layers of nested sub-sections to create for generating a content item. The LLM may base its determination on several factors, including the type and amount of data available and authorized for user access.

In some embodiments, the template and the data populated in the template may be dependent on which user requests the generation of the content item. In this embodiment, different tiers of access levels may be associated with different tiers of employees based on their job titles, such as a manager having authorized access to a higher level of private data/data items than an associate or a contractor. Private data associated with the highest level of access to confidential and proprietary enterprise data and may be reserved for employees with highest level of clearance to access such authorized data, such as the CEO or C-suite employees, and may not be made available to employees with lower tier of access. Further proprietary enterprise data relevant to one department may not be authorized to be accessible by another employee whose job function does not relate to such department. As such, in some embodiments, both identity of the user and the enterprise may be used in determining which data items from the data sources to use for generating the semantic graph. Accordingly, the semantic graph may be different for each user, employees, etc.

Since data only from only those data sources for which the user is authorized access may be used in generating the semantic graph, all the pieces, such as the semantic graph, the template, and the content item generated may be customized to each user based on their authorized level of access to data.

Furthermore, the semantic graph, the template, and the content item generated may also be customized to the enterprise. Since each enterprise has different types of data, different locations of data storage, and different strategy of data completion and storage, including different approaches to writing styles, writing strategy, additional sections to include in a document, etc., the semantic graph, the template, and the content item generated may be specific to the enterprise based on all their restrictions and preferences.

FIG. 12 is a flowchart of an example of a process 1200 for performing a search query to populate section(s) of the generated template, in accordance with some embodiments of the disclosure. Process 1200 may be implemented, in whole or in part, by systems or devices such as those shown in FIGS. 2-3. One or more actions of the process 1200 may be incorporated into or combined with one or more actions of any other process or embodiments described herein. The process 1200 may be saved to a memory or storage (e.g., any one of those depicted in FIGS. 2-3) as one or more instructions or routines that may be executed by a corresponding device or system to implement the method 1200. The process may include generating a template using an LLM. The template may then be populated by querying the semantic graph for data.

In some embodiments, once a template is finalized, a search query may be made at block 1210 for each section in the template to the semantic graph 1220. The order of the search query may be based on the hierarchical order of the sections and sub sections in the generated template. In one embodiment, as described earlier, the search query may start from the deepest and most nested layer or subsection in the generated template. For example, as depicted in FIG. 10, the deepest nested leaf/bottom most nested layer/most fine-grained subsection in Section 1 may be section 1.1.1.1 and 1.1.1.2, which are in layer 4 of the section tree. Since both section 1.1.1.1 and 1.1.1.2 are in the same layer, i.e., layer 4, a search query for both sections in layer 4 may be sent to the semantic graph simultaneously and at the same time.

The search query for the selected section or sections may be sent to the semantic graph 1220. The semantic graph information and the search query information may both be fed into a generation model 1230. The generation model, guided by the search query, may leverage the semantic graph (which may also me generated based on leveraging an LLM) to determine which data to obtain for the section that is to be written. Since the semantic graph may index the data to the data sources where such data is stored, the generation model may leverage the semantic graph and obtain the indexed data that is relevant to the current section that is to be written from the data source. Once the data is obtained, the generation model may perform a section write up at 1240. The order of writing to the section may mirror the order of the search query. Using the earlier example where a search query was made for both sections in layer 4 (section 1.1.1.1 and 1.1.1.2) to the semantic graph, at block 1240 the generation model may write in parallel and simultaneously to both sections 1.1.1.1 and 1.1.1.2. In other words, the system may Parallelize the data calls made to the semantic graph for independent sections in the template when they are on a same layer.

At block 1250, the generation model may write to the content item, such as a document, presentation, slide, excel, or another type of content item. The written section may then be displayed on a display of a user interface 1260 to the user. The user may then provide feedback for the written section using the user interface. Some examples of providing feedback are depicted in FIGS. 15 and 16.

Once feedback to the section is provided, the feedback may be used by the search query to once again search the semantic graph based on the received feedback. In doing so, the system may perform status management 1280 to maintain the previous status. In other words, the status of what has already been built and written may be maintained and only the change that is needed based on the feedback may be made. By maintaining status, the system may save computing resources and time that would otherwise be used to regenerate the entire section or the entire content item.

The dynamic and real-time technique of providing per layer feedback and regenerating the section, and any other data or sections that rely on the feedback, may be used to provide feedback on multiple sections at a time. Unlike chatbots that can only take on feedback at a time, the embodiments may allow multiple feedbacks for a same section or for several sections at a time, or within a short duration. For example, a user may provide feedback for 5, 10, 60, or any number of sections within seconds and receive an updated output that incorporates the feedback.

The process of performing the search query on a layer-by-layer basis may repeated until all the sections in the content item are written. As such, a coherent content item, which may be several pages, such as 5, 10, 1000, or more pages, that is logically presented and correlated (and cross-referenced as needed) section by section may be generated.

In some embodiments, the bottoms up approach used may allow the system to write a broader and more explanatory section that precedes the written section. For example, if the deepest nested leaf/bottom most nested layer/most fine-grained subsection written is section A.1 then the section above, which may be Section A, may be abstracted on a higher level than section A.1. In other words, Section A may be a higher-level summary of which further details may be provided in subsection A.1. For example, if subsection A.1 describes the maximum number of days an employee can take leave, the section above, which is Section A may lay the groundwork for section A.1 and as such describe the leave policy.

FIG. 13 is an example of a bottoms up approach in writing content into the generated template, in accordance with some embodiments of the disclosure. The system may apply a formula (L=Lᵢ)=Template (Lᵢ)+Summary of each child of Lᵢ. Applying this formula, the deepest nested leaf/bottom most nested layer/most fine-grained subsection, which is the bottom most child, such as Section 2 . . . n, may be queried and written first then followed by higher level sections 2.1.1.1, 2.1.1, 2.1, and 2.

FIG. 14 is an example of a querying and writing order based on section hierarchy for writing content into the generated template, in accordance with some embodiments of the disclosure. In this example, the deepest nested leaf/bottom most nested layer/most fine-grained subsection may be section 3.2.1.1.1 then followed by sections 3.2.1.1 and 3.2.1.2 at the next level up. Based on the bottoms up approach, i.e. to query and write deepest nested leaf/bottom most nested layer/most fine-grained subsection first followed by higher level sections, section 3.2.1.1.1 may be queried and written first. Since sections 3.2.1.1 and 3.2.1.2 are at a same level/layer, they both may be queried and written in parallel.

FIG. 15 is an example of obtaining and processing a per layer or section-by-section feedback in accordance with some embodiments of the disclosure. In some embodiments, the process of providing feedback may include highlighting the section or subsection for which feedback is to be provided. For example, as depicted in FIG. 15, section 1510 is highlighted and identified for feedback. The highlighting may be automatic if the user's mouse, trackpad, finger, or cursor hovers over the section or subsection. The highlighting for editing and providing feedback may visually distinguish the section or subsection from other sections and subsections for which feedback is not being currently provided.

If a section or subsection is hovered upon, selected, or highlighted, then the control circuitry 220 and/or 228, in some embodiments, may automatically provide editing suggestions 1520. In some embodiments, the automatically provided editing suggestions may be based on determining user's preferences, prior edits, and patterns using machine learning techniques. In other embodiments, the automatically provided editing suggestions may also be based on preferences of other colleagues or the enterprise accepted policies. For example, other documents from colleagues or documents used in the enterprise may be fed into an LLM to determine colleagues and enterprise preferences, and recommendation may be made from the LLM on how the current content item is to be edited based on the inputted documents from colleagues and enterprise.

In one example, as depicted at 1520, the system provides the following editing and feedback options: Make it formal, improve text, make it longer, make it shorter, and custom. These are just some examples and any other form of suggestion may also be displayed on the user interface of the user in real time when the user's mouse, trackpad, finger, or cursor hovers over the section or subsection The user may also be able to select the custom icon and enter any feedback as desired. The system may leverage LLM models to use revise the sections for which feedback is provided. The system may do so by performing status management of the previous status, using the feedback to perform a search query to the semantic graph, and use the search query and the semantic graph as input into a generation model for updating the section based on the feedback provided.

Although highlighting is used in the above embodiment to identify the section for editing, provide suggestions, and regenerate the section, other methods such as bolding the text, coloring the text, italicizing the text, or using some other form to visually distinguish the text for feedback may also be used.

FIG. 16 is an example of receiving feedback, editing and/or suggesting edits based on feedback, and regenerating the write-up, in accordance with some embodiments of the disclosure. In this embodiment, if the user makes a selection of the section, such as the section written by the generation model in FIG. 12, then the system may provide one or more suggestion on how the section can be rewritten or enhanced. As depicted in this embodiment, Section 1.1.1.1 may have been written by the generation model in FIG. 12 and displayed on the user interface of the user. Upon selection, the user may type in custom feedback such as “Please shorten to lesser words and use simple words” 1620. The system may then maintain state and process the feedback by querying the semantic graph. The system may then, as depicted at block 1630, generate Options 1-3, as an example, of rewriting options for approval by the user. Once the user approves, the section may be dynamically replaced with the approved writeup. In some embodiments, the system may automatically regenerate the section, without needing further user approval, and provide an undo button on the user interface allowing the user to change back to the earlier state if the user is not satisfied with the regenerated writeup.

It will be apparent to those of ordinary skill in the art that methods involved in the above-mentioned embodiments may be embodied in a computer program product that includes a computer-usable and/or -readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. More generally, the above disclosure is meant to be exemplary and not limiting. Only the claims that follow are meant to set bounds as to what the present invention includes. The processes and features described herein may also include, in some embodiments, the user, via a user device, may issue a query to generate a proposal for the template the user or the system has provided and a document, such as a request-for-proposal document, the user has uploaded. The query my then enter an orchestrator system (also referred to as a agent router) and be redirected to the appropriate component to create a proposal, e.g., an agent. Based on the user query, the agent may determine whether it already has a template to generate the proposal. If it already has the template, then the agent may retrieve the existing template. However, if a determination is made by the agent that a template does not exists, then the agent may generate a new template based on instructions added by the user (as a document, conversation or fallback default templates) or system, or based on an LLM recommendation. Once the template is generated, based on the template's outline of sections of the long-form-content for a proposal, an execution plan on how to get information and fill in the different set of sections of the proposal may be determined. This includes determining which sections can be filled in parallel, which needs to be added in sequence on others for e.g. sections like introduction, conclusions etc. Such a determination may be guided by an LLM. Based on the execution plan, relevant data (from different data providers) may be retrieved. This process may be performed for all the sections and subsections in the template. Once all the sections are generated, the output may be formatted according to the user or system provided guidelines. The content in all section may be modified to ensure coherency is maintained and any redundancies are minimized or removed.

Additionally, it should be noted that although references are made to large language models (LLM), smaller language models, and smaller neural networks may also be used in its place.

Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method comprising:
receiving a request from a user device for generating a content item using private enterprise data items;
generating a template containing a table of contents section, which includes a plurality of nested subsections, for the content item to be generated;
identifying a section from the generated template for performing a write operation;
querying a semantic graph for accessing private enterprise data items for the identified section, wherein the semantic graph indexes only those private enterprise data items that are authorized for the user device to access; and
performing a write operation in the identified section based on the private enterprise data items obtained by querying the semantic graph.

2. The method of claim 1, wherein generating the template comprises:
generating an initial template;
verifying the initial template via user input; and
generating the template containing the table of contents based on the verified user input.

3. The method of claim 1, further comprising generating the semantic graph, wherein the generation of the semantic graph comprises:
detecting establishing of a connection between a user device and a plurality of data sources;
performing an automatic initial synchronization of private enterprise data items from the plurality of data sources in response to detecting the establishing of the connection; and
generating the semantic graph based on the initial synchronization of private enterprise data items from the plurality of data sources.

4. The method of claim 3, wherein the semantic graph provides associations between private enterprise data items from a plurality of data sources.

5. The method of claim 3, further comprising:
determining a change in a private enterprise data item from a first data source, from the plurality of data sources;
performing a subsequent synchronization with the first data source to obtain the changed private enterprise data item; and
regenerating a portion of the semantic graph effected by the changed private enterprise data item.

6. The method of claim 1, further comprising:
automatically determining that a task is to be performed by the user device; and
suggesting, to the user device, one or more templates that correlate to the task to be performed.

7. The method of claim 6, wherein the task to be performed is determined by analyzing a plurality of communications associated with the user device.

8. The method of claim 1, wherein identifying the section from the generated template for performing a write operation comprises:
identifying a bottom most sub section from the plurality of nested subsections for a particular section; and
selecting the bottom most sub section for performing the write operation.

9. The method of claim 1, further comprising:
determining that a first nested subsection and a second nested subsection, from the plurality of nested subsections, are on a same layer; and
simultaneously writing content for the first nested subsection and the second nested based on both subsections being on the same layer.

10. The method of claim 1, further comprising:
querying the semantic graph for obtaining private enterprise data items for all remaining sections in the generated template;
performing a write operation for all the remaining sections starting with a section at a bottom of a section hierarchy to a section at the top of the hierarchy; and
providing a completed content item upon completion of the write operation for all the remaining sections.

11. The method of claim 1, wherein the semantic graph indexes data sources that contain the private enterprise data items that are to be used to perform the write operation for the identified section.

12. The method of claim 1, further comprising generating the semantic graph using a large language model (LLM).

13. A system comprising:
communication circuitry configured to access a user device; and
control circuitry configured to:
receive a request from the user device for generating a content item using private enterprise data items;
generate a template containing a table of contents section, which includes a plurality of nested subsections, for the content item to be generated;
identify a section from the generated template for performing a write operation;
query a semantic graph for accessing private enterprise data items for the identified section, wherein the semantic graph indexes only those private enterprise data items that are authorized for the user device to access; and
perform a write operation in the identified section based on the private enterprise data items obtained by querying the semantic graph.

14. The system of claim 13, wherein generating the template comprises, the control circuitry configured to:
generate an initial template;
verify the initial template via user input; and
generate the template containing the table of contents based on the verified user input.

15. The system of claim 13, further comprising, the control circuitry configured to generate the semantic graph, wherein the generation of the semantic graph comprises:
detecting establishing of a connection between a user device and a plurality of data sources;
performing an automatic initial synchronization of private enterprise data items from the plurality of data sources in response to detecting the establishing of the connection; and
generating the semantic graph based on the initial synchronization of private enterprise data items from the plurality of data sources.

16. The system of claim 15, wherein the semantic graph provides associations between private enterprise data items from a plurality of data sources.

17. The system of claim 15, further comprising, the control circuitry configured to:
determine a change in a private enterprise data item from a first data source, from the plurality of data sources;
perform a subsequent synchronization with the first data source to obtain the changed private enterprise data item; and
regenerate a portion of the semantic graph effected by the changed private enterprise data item.

18. The system of claim 13, further comprising, the control circuitry configured to:
automatically determine that a task is to be performed by the user device; and
suggest, to the user device, one or more templates that correlate to the task to be performed.

19. The system of claim 13, further comprising, the control circuitry configured to:
determine that a first nested subsection and a second nested subsection, from the plurality of nested subsections, are on a same layer; and
simultaneously write content for the first nested subsection and the second nested based on both subsections being on the same layer.

20. The system of claim 13, further comprising, the control circuitry configured to generate the semantic graph using a large language model (LLM).
